(19) United States
(12) Patent Application Publication
(10) Pub. No.: US 2003/0079763 A1
(43) Pub. Date: May 1, 2003

(54) Apparatus for cleaning wafers

(76) Inventor: Chang-Hyeon Nam, Yongin-Shi (KR)

Correspondence Address: VOLENTINE FRANCOS, P.L.L.C., Suite 150, 12200 Sunrise Valley Drive, Reston, VA, 20191, US

(21) Appl. No.: 10/281,205

(22) Filed: Oct. 28, 2002

(30) Foreign Application Priority Data
Oct. 29, 2001 (KR) 66895/2001

(51) Int. Cl. B08B 3/00

(52) U.S. Cl. 134/95.2; 134/113; 134/157; 134/186

(57) ABSTRACT

Cleaning solution supply units provide cleaning solutions to a tank equipped with a wafer mounting unit on which a wafer is mounted. Drain outlets are provided which drain the respective cleaning solutions from the tank, and a motor is used to rotate the rotatable wafer mounting unit to conduct a spin dry process within the tank. An isopropyl alcohol (IPA) vapor supply unit is provided supplies an IPA vapor to the tank to conduct an IPA pressure reduction dry process within the tank. Valves are used to selectively place the tank in fluid communication with the cleaning solution supply units, the drain outlets and the IPA vapor supply unit.

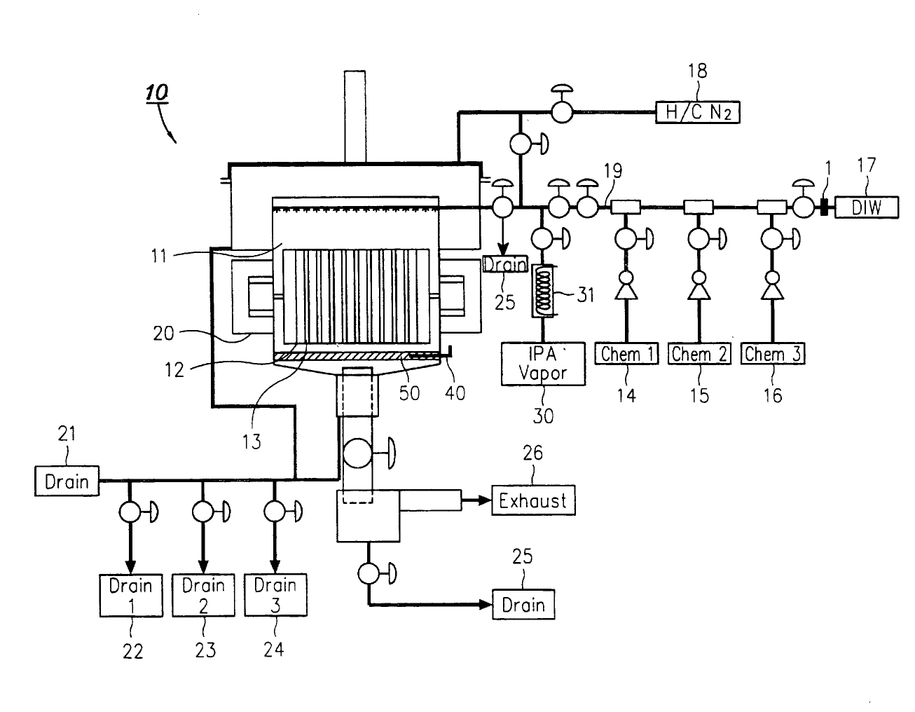

### BACKGROUND OF THE INVENTION

1. Field of the Invention

The present invention generally relates to a cleaning apparatus for cleaning and drying a semiconductor wafer, and more particularly, the present invention relates to an apparatus for performing a cleaning process and for selectively performing different drying processes, such as a spin drying and an IPA(isopropyl alcohol) vapor drying process, depending on conditions of the cleaning process.

A claim of priority is made to an application entitled “Apparatus for Cleaning Wafers” which filed in the Korean Industrial Property Office on Oct. 29, 2001 and assigned Ser. No. 01-66895, the contents of which are incorporated herein by reference.

2. Description of the Related Art

Wafer contamination can substantially reduce device yields, and accordingly, cleaning technologies have become of increased importance in the manufacture of highly integrated semiconductor devices. Particles causing wafer contamination can be generated from a variety of sources, including exposure to air flow, equipment, parts, and the environment, and the development of technologies which minimize exposure to such sources is presently being pursued.

Generally, chemical cleaning of the surface of a wafer is carried out in a cleaning process before conducting certain processes, such as high temperature reflow or chemical vapor deposition (CVD). An RCA cleaning method is widely used in such instances.

Generally, wafers are cleaned using an SC-1 solution (NH₄OH+H₂O₂+H₂O) and SC-2 solution (HCl+H₂O₂+H₂O). The SC-1 solution is said to be an alkaline cleaning, since it is used in eliminating organic substances on the wafer, and the SC-2 solution is said to be an acid cleaning, since it is used in eliminating inorganic substances on the wafer.

In addition to the SC-1 and SC-2 cleaning solutions, (H₂SO₄+H₂O₂) is used for initial wafer cleaning and after elimination of a photo resist, and diluted HF is widely used for elimination of naturally generated oxide films and inorganic contaminating substances.

The wafer cleaned by the foregoing cleaning solutions undergoes a drying process using a drying apparatus, for which a manual open-bath type apparatus and an automatic apparatus have been widely used.

The open-bath type apparatus, however, needs a chemical solution tank and a washing tank, so that a large space is required. In the meantime, the automatic apparatus inevitably results in an opening of the cleaning apparatus due to movement of a robot between baths. Therefore, the problem arises of adsorption of the contaminating particles such as organic substances and particles on the surface of the wafer. Also, water molecules on the wafer surface come into contact with oxygen in the air, generating a water mark depending on surface characteristics of the wafer.

### SUMMARY OF THE INVENTION

Accordingly, one objective of the present invention is to provide an apparatus for cleaning a wafer which minimizes exposure of the wafer to contaminating particles during a subsequent drying process.

Another objective of the present invention is to provide an apparatus for cleaning a wafer which minimizes exposure of the wafer to air until a cleaning process and a dry process are completed.

Still another objective of the present invention is to provide an apparatus for cleaning a wafer which has maximal cleaning characteristics.

The foregoing and other objectives and advantages are at least partially realized by an apparatus for cleaning a wafer which includes a tank; a rotatable wafer mounting unit located within the tank; a plurality of cleaning solution supply units which provide respective cleaning solutions to the tank; a plurality of drain outlets which drain the respective cleaning solutions from the tank; a motor which rotates the rotatable wafer mounting unit to conduct a spin dry process within the tank; an isopropyl alcohol (IPA) vapor supply unit which supplies an IPA vapor to the tank to conduct an IPA pressure reduction dry process within the tank; and a plurality of valves for selectively placing the tank in fluid communication with the plurality of cleaning solution supply units, the plurality of drain outlets and the IPA vapor supply unit.

### BRIEF DESCRIPTION OF THE DRAWING

The invention will be described in detail with reference to the accompanying drawing which schematically illustrates a cleaning apparatus according to one embodiment of the present invention.

### DETAILED DESCRIPTION OF THE PREFERRED EMBODIMENT

The accompanying drawing schematically illustrates a combination type cleaning apparatus 10 according to an embodiment of the present invention which performs cleaning and drying processes while inhibiting the wafer from exposure to air and other contamination particles. As shown, the cleaning apparatus 10 includes a wafer mounting unit 12 that is installed within a tank 11. The wafer mounting unit 12 is preferably configured for mounting of a plurality of wafers 13 thereon.

The present embodiment of the invention adopts a combination type cleaning apparatus of a closed type so as to minimize exposure of the wafer to air, and particularly, the present embodiment performs procedures utilizes nitrogen gas (N₂) during drying processes subsequent to cleaning to minimize contact with air within the cleaning apparatus.

A supply line 19 is installed on an upper side of the wafer mounting unit 12 within the chemical solution tank 11, and a plurality of cleaning solution supply units 14, 15 and 16 are selectively placed in fluid communication with the tank 11 through the supply line 19 and valves (unnumbered). Also, an isopropyl alcohol (IPA) vapor supply unit 30 which selectively provides IPA vapor through the supply line 19 to carry out an IPA pressure reduction dry process, a nitrogen supply unit 18 which supplies nitrogen gas during drying, and a DI (deionized) water rinse supply unit 17 are installed respectively on one side of the supplying line 19. The cleaning solution supplying unit 14, 15 and 16, and the IPA vapor supplying unit 30, the nitrogen supplying unit 18, and the DI water rinse supplying unit 17 are installed so as to be selectively in fluid communication with the tank 11 through the same supply line 19.

Also, a mega-sonic oscillator 50 is installed on a lower end of the chemical solution tank 11 to enhance cleaning power by the use of ultrasonic waves which may be variably controlled depending on process parameters and wafer patterns upon performance of chemical cleaning or QDR (Quick Dump Rinse). In the mega-sonic oscillator, an oscillating plate of a circular type (curved type), not a plate type of a related art, may be used so that partial loss of the mega-sonic power is avoided.

Also, a plurality of drain outlets 21, 22, 23, and 24 are installed on a lower portion of the chemical solution tank 11 for selectively draining waste chemicals in order to dispose of the plurality of the waste chemicals as they are used. For the drain outlets 21, 22, 23, and 24, an automatic drain system can be used which is selectively opened according to a PH density measured by a hydrogen ion density measuring instrument 40 installed on the chemical solution tank 11. A separate drain outlet 25 may be installed on a lower side of the chemical solution tank 11 so that water contained in the chemical solution tank 11 is separately drained. Also, an exhaust port 26 for swift exhaustion of nitrogen, for example, from the tank 11 is installed on a upper side of the drain outlet 25. The exhaust port 26 may be positioned higher than the drain outlet 25, that is, about 20-50 mm higher than the drain outlet 25.

Also, in the cleaning process, the wafer mounting unit 12 within the chemical solution tank 11 is installed so that it rotates by operation of a variable motor 20 so as to prevent dispersion in an etched amount on upper and lower surfaces of the wafer and cleaning deterioration, thus maximizing a cleaning effect.

The cleaning apparatus 10 according to the present embodiment is configured such that selection of a drying process depending on pattern conditions of the devices is possible. Namely, for the case of there being no water mark or pattern, the spin drying method using high speed rotation induced by the variable motor 20 could be used. On the contrary, for the case of a process vulnerable to a water mark or complex pattern structure, the drying method by IPA pressure reduction drying could be used.

The spin drying method according to an embodiment of the present invention, unlike a method of the related art, raises the number of rotations right after the cleaning process, inspiring cool and warm nitrogen of a high degree of purity to effect drying. Preferably, a resultant wind force is exhausted swiftly by the exhaust port 26. The variable motor 20 may be installed in a manner using an electromagnet having a lining made of Teflon of a fluoric resin type so that the electromagnet does not come into direct contact with the chemical solution. Also, though not shown, a carrier guide may be provided having a lining of Teflon of a fluoric resin series on a material made of SUS series (SUS 316) so that bending or transformation is not generated due to external conditions.

Also, in an IPA pressure reduction drying method, an external tank is drained firstly with the wafer dipped after processing of chemicals and final washing, and IPA vapor provided from the IPA vapor supply unit 30 is injected and at the same time deionized water is slowly discharged. The moment the wafer is exposed to air, the wafer comes across the IPA vapor and a drying process commences. In order to suppress generation of organic particles, the wafer may be dried using a blow process of warm nitrogen after performance of the vapor pressure reduction drying. An IPA vapor amount and warm nitrogen blow amount may be adjusted by applying pressure and supplying a pump flux.

As is apparent from the foregoing, the cleaning apparatus according to the present invention is capable of selectively performing a spin drying process and an IPA pressure reduction drying depending on pattern conditions of the wafer, thereby protecting the wafer from external contaminating particles.

While the invention has been shown and described with reference to certain preferred embodiments thereof, it will be understood by those skilled in the art that various changes in form and details may be made therein without departing from the spirit and scope of the invention as defined by the appended claims. Likewise, the foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. An apparatus for cleaning a wafer, comprising:
a tank;
a rotatable wafer mounting unit located within the tank;
a plurality of cleaning solution supply units which provide respective cleaning solutions to the tank;
a plurality of drain outlets which drain the respective cleaning solutions from the tank;
a motor which rotates the rotatable wafer mounting unit to conduct a spin dry process within the tank;
an isopropyl alcohol (IPA) vapor supply unit which supplies an IPA vapor to the tank to conduct an IPA pressure reduction dry process within the tank; and
a plurality of valves for selectively placing the tank in fluid communication with the plurality of cleaning solution supply units, the plurality of drain outlets and the IPA vapor supply unit.

2. The apparatus according to claim 1, wherein the motor is a variable spin motor.

3. The apparatus according to claim 1, wherein the plurality of cleaning solution supply units and the IPA vapor supply unit are selectively placed in fluid communication with the tank through a same supply line.

4. The apparatus according to claim 1, further comprising a deionized water (DIW) rinse supply unit which supplies DIW to the tank.

5. The apparatus according to claim 4, wherein the plurality of cleaning solution supply units, the IPA vapor supply unit and the DIW rinse supply unit are selectively in fluid communication with the tank through a same supply line.

6. The apparatus according to claim 1, further comprising an exhaust port which exhausts an atmosphere within the tank during the spin dry process.

7. The apparatus according to claim 6, wherein the exhaust port is located in a bottom region of the tank, and wherein the apparatus further comprises a drain outlet which drains a cleaning solution contained in an exhaust path of the exhaust port.

8. The apparatus according to claim 1, further comprising a hydrogen ion density measuring instrument installed on the tank.

9. The apparatus according to claim 1, further comprising a mega-sonic oscillator installed on a lower side of the chemical solution tank.

10. The apparatus according to claim 1, further comprising a nitrogen gas supply which supplies nitrogen gas to the tank.
